(19) United States
(12) Patent Application Publication
(10) Pub. No.: US 2015/0373492 A1
(43) Pub. Date: Dec. 24, 2015

(54) LOCATION-BASED SERVICE PROVISIONING

(71) Applicant: OneWhistle, Inc., Cupertino, CA (US)

(72) Inventor: Raja M. Appachi, Cupertino, CA (US)

(73) Assignee: OneWhistle, Inc., Cupertino, CA (US)

(21) Appl. No.: 14/746,706

(22) Filed: Jun. 22, 2015

Related U.S. Application Data
(60) Provisional application No. 62/015,278, filed on Jun. 20, 2014.

(51) Int. Cl. H04W 4/02

(52) U.S. Cl. CPC H04W 4/023

(57) ABSTRACT

A geographic map is seeded with location-based service offering in real-time. A whistle for services in a geographic location within the geographic map is monitored. Service providers having characteristics indicative of suitability for timely providing at the geographic location a location-based service identifiable from the location-based service offerings when a whistle event requesting the location-based service is created are alerted. Provisioning of the location-based service provided in response to the whistle for services is tracked.

### CROSS-REFERENCE TO RELATED APPLICATIONS

This application claims priority to U.S. Provisional Patent Application No. 62/015,278, filed Jun. 20, 2014, and entitled “LOCATION-BASED SERVICE PROVISIONING,” which is incorporated by reference.

### BACKGROUND

An area of ongoing research and development is providing networking services to people. In particular, problems exist in connecting people based on location.

Other limitations of the relevant art will become apparent to those of skill in the art upon a reading of the specification and a study of the drawings.

### SUMMARY

The following implementations and aspects thereof are described and illustrated in conjunction with systems, tools, and methods that are meant to be exemplary and illustrative, not necessarily limiting in scope. In various implementations, one or more of the above-described problems have been addressed, while other implementations are directed to other improvements.

In various implementations, a geographic map is seeded with location-based service offering in real-time. Further, in various implementations, a whistle for services in a geographic location within the geographic map is monitored. In various implementations, service providers having characteristics indicative of suitability for timely providing at the geographic location a location-based service identifiable from the location-based service offerings when a whistle event requesting the location-based service is created are alerted. Additionally, in various implementations, provisioning of the location-based service provided in response to the whistle for services is tracked.

These and other advantages will become apparent to those skilled in the relevant art upon a reading of the following descriptions and a study of the several examples of the drawings.

### BRIEF DESCRIPTION OF THE DRAWINGS

FIG. 1 depicts a diagram of an example of a system for providing services to users based on locations of the users.

FIG. 2 depicts a diagram of an example of a system for registering users for providing networking services based on location.

FIG. 3 depicts a diagram of an example of a system for providing location-based services.

FIG. 4 depicts a diagram of an example of a system for obtaining feedback of users and entities in providing and obtaining location-based services.

FIG. 5 depicts a flowchart of an example of a method for providing services based on user location.

FIG. 6 depicts a flowchart of an example of a method for providing brokering services to users.

FIG. 7 depicts a flowchart of another example of a method for providing brokering services through location-based services.

FIG. 8 depicts an example of a flowchart for providing location-based services including brokering services, and management services based on user location.

FIG. 9 depicts a flowchart of an example of a method for providing location-based services to users by matching personas.

FIG. 10 depicts a flowchart of an example of a method for provisioning location-based services.

### DETAILED DESCRIPTION

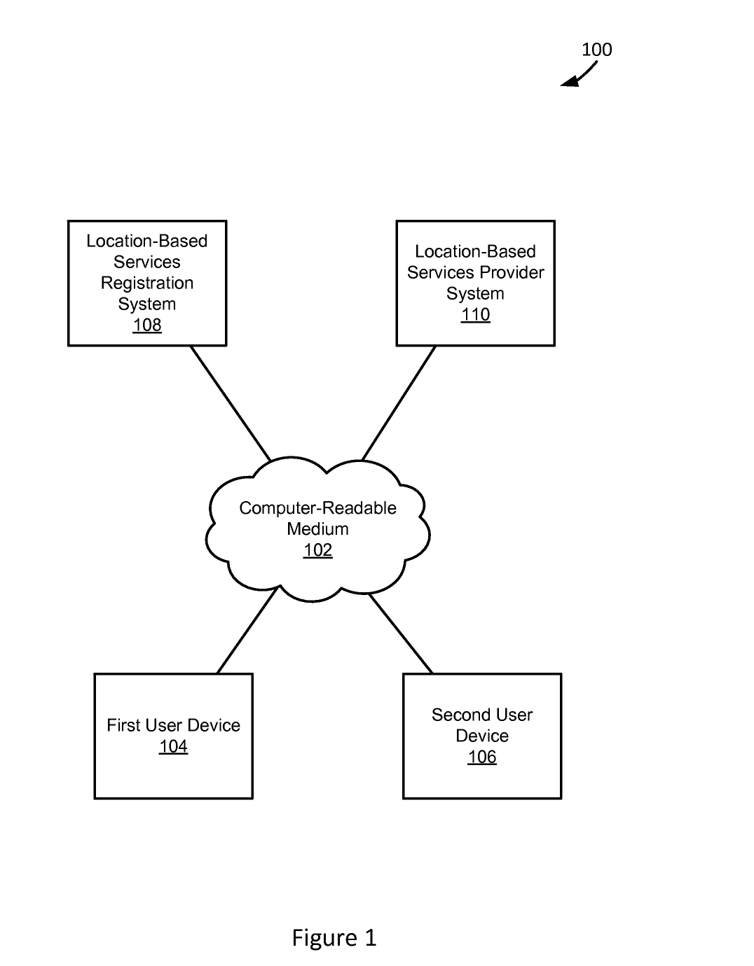

FIG. 1 depicts a diagram 100 of an example of a system for providing services to users based on locations of the users. The system of the example of FIG. 1 includes a computer-readable medium 102, a first user device 104, a second user device 106, a location-based services registration system 108, and a location-based services provider system 110.

The first user device 104, the second user device 106, the location-based services registration system 108, and the location-based services provider system 110 are coupled to each other through the computer-readable medium 102. As used in this paper, a “computer-readable medium” is intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware.

The computer-readable medium 102 is intended to represent a variety of potentially applicable technologies. For example, the computer-readable medium 102 can be used to form a network or part of a network. Where two components are co-located on a device, the computer-readable medium 102 can include a bus or other data conduit or plane. Where a first component is co-located on one device, and a second component is located on a different device, the computer-readable medium 102 can include a wireless or wired back-end network or LAN. The computer-readable medium 102 can also encompass a relevant portion of a WAN or other network, if applicable.

The computer-readable medium 102, the first user device 104, the second user device 106, the location-based services registration system 108, the location-based services provider system 110, and other applicable systems, or devices described in this paper can be implemented as a computer system, a plurality of computer systems, or parts of a computer system or a plurality of computer systems. A computer system, as used in this paper, is intended to be construed broadly. In general, a computer system will include a processor, memory, non-volatile storage, and an interface. A typical computer system will usually include at least a processor, memory, and a device (e.g., a bus) coupling the memory to the processor. The processor can be, for example, a general-purpose central processing unit (CPU), such as a microprocessor, or a special-purpose processor, such as a microcontroller.

The memory can include, by way of example but not limitation, random access memory (RAM), such as dynamic RAM (DRAM) and static RAM (SRAM). The memory can be local, remote, or distributed. The bus can also couple the processor to non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

Software is typically stored in the non-volatile storage. Indeed, for large programs, it may not even be possible to store the entire program in the memory. Nevertheless, it should be understood that for software to run, if necessary, it is moved to a computer-readable location appropriate for processing, and for illustrative purposes, that location is referred to as the memory in this paper. Even when software is moved to the memory for execution, the processor will typically make use of hardware registers to store values associated with the software and local cache that ideally serves to speed up execution. As used herein, a software program is assumed to be stored at an applicable known or convenient location (from non-volatile storage to hardware registers) when the software program is referred to as “implemented in a computer-readable storage medium.” A processor is considered to be “configured to execute a program” when at least one value associated with the program is stored in a register readable by the processor.

In one example of operation, a computer system can be controlled by operating system software, which is a software program that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus can also couple the processor to the interface. The interface can include one or more input and/or output (I/O) devices. The I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liquid crystal display (LCD), or some other applicable known or convenient display device. The interface can include one or more of a modem or network interface. It will be appreciated that a modem or network interface can be considered to be part of the computer system. The interface can include an analog modem, isdn modem, cable modem, token ring interface, satellite transmission interface (e.g. “direct PC”), or other interfaces for coupling a computer system to other computer systems. Interfaces enable computer systems and other devices to be coupled together in a network.

The computer systems can be compatible with or implemented as part of or through a cloud-based computing system. As used in this paper, a cloud-based computing system is a system that provides virtualized computing resources, software and/or information to client devices. The computing resources, software and/or information can be virtualized by maintaining centralized services and resources that the edge devices can access over a communication interface, such as a network. “Cloud” may be a marketing term and, for the purposes of this paper, can include any of the networks described herein. The cloud-based computing system can involve a subscription for services or use a utility pricing model. Users can access the protocols of the cloud-based computing system through a web browser or other container application located on their client device.

A computer system can be implemented as an engine, as part of an engine, or through multiple engines. As used in this paper, an engine includes one or more processors or a portion thereof. A portion of one or more processors can include some portion of hardware less than all of the hardware comprising any given one or more processors, such as a subset of registers, the portion of the processor dedicated to one or more threads of a multi-threaded processor, a time slice during which the processor is wholly or partially dedicated to carrying out part of the engine's functionality, or the like. As such, a first engine and a second engine can have one or more dedicated processors, or a first engine and a second engine can share one or more processors with one another or other engines. Depending upon implementation-specific or other considerations, an engine can be centralized or its functionality distributed. An engine can include hardware, firmware, or software embodied in a computer-readable medium for execution by the processor. The processor transforms data into new data using implemented data structures and methods, such as is described with reference to the FIGS. in this paper.

The engines described in this paper, or the engines through which the systems and devices described in this paper can be implemented, can be cloud-based engines. As used in this paper, a cloud-based engine is an engine that can run applications and/or functionalities using a cloud-based computing system. All or portions of the applications and/or functionalities can be distributed across multiple computing devices, and need not be restricted to only one computing device. In some embodiments, the cloud-based engines can execute functionalities and/or modules that end users access through a web browser or container application without having the functionalities and/or modules installed locally on the end-users' computing devices.

As used in this paper, datastores are intended to include repositories having any applicable organization of data, including tables, comma-separated values (CSV) files, traditional databases (e.g., SQL), or other applicable known or convenient organizational formats. Datastores can be implemented, for example, as software embodied in a physical computer-readable medium on a general- or specific-purpose machine, in firmware, in hardware, in a combination thereof, or in an applicable known or convenient device or system. Datastore-associated components, such as database interfaces, can be considered “part of” a datastore, part of some other system component, or a combination thereof, though the physical location and other characteristics of datastore-associated components is not critical for an understanding of the techniques described in this paper.

Datastores can include data structures. As used in this paper, a data structure is associated with a particular way of storing and organizing data in a computer so that it can be used efficiently within a given context. Data structures are generally based on the ability of a computer to fetch and store data at any place in its memory, specified by an address, a bit string that can be itself stored in memory and manipulated by the program. Thus, some data structures are based on computing the addresses of data items with arithmetic operations; while other data structures are based on storing addresses of data items within the structure itself. Many data structures use both principles, sometimes combined in non-trivial ways. The implementation of a data structure usually entails writing a set of procedures that create and manipulate instances of that structure. The datastores, described in this paper, can be cloud-based datastores. A cloud-based datastore is a datastore that is compatible with cloud-based computing systems and engines.

In a specific implementation, the first user device 104 and the second user device 106 function to send and receive data such that either or both a first user and a second user can utilize services based on their corresponding locations. Depending upon implementation-specific or other considerations, the first user device 104 and the second user device 106 can include a wireless interface through which the first user device 104 and the second user device 106 can be coupled to the computer-readable medium 102 and subsequently other devices, systems or engines coupled to the computer-readable medium 102 through a wireless connection. Further depending upon implementation-specific or other considerations, the first user device 104 and the second user device 106 can be a thin client device or an ultra-thin client device. The first user device 104 and the second user device 106 can include applicable mechanisms for determining the location of the first user device 104 and the second user device 106, and subsequently the position of a first user associated with the first user device 104 and a second user associated with the second user device 106. For example, the first user device 104 and the second user device 106 can include global positioning system (hereinafter referred to as “GPS”) receivers used to calculate the location of the first user device 104 and the second user device 106.

In a specific implementation, the location-based services registration system 108 functions to register a user with a location-based services provider system. In registering a user with a location-based services provider system, the location-based services registration system can authorize a user to use and/or perform services provided by a locations based services provider system.

In a specific implementation, the location-based services registration system 108 can receive and/or generate user data for a user registered by the location-based services registration system 108. User data received and/or generated by the location-based services registration system 108 can include persona data and whistle data. Examples of user data include a name of a user, an age of a user, a gender of a user, a location of a user, a likeness of a user, contact information of a user, and payment information of a user, e.g. a credit card number. For example, a user can input their geographic location as part of the registration process. A geographical location input by a user can be a location of the user at the time of registration, or a location occupied by a user more often than other locations. User data received and/or generated by the location-based services registration system 108 can include user preferences. User preferences can include descriptions of people to which a user prefers to be connected or otherwise networked, services that a user is interested in exploiting through a location-based services provider system, and services that a user is willing to perform for other users.

In a specific implementation, the location-based services registration system 108 can perform a background check on a user being registered. In performing a background check of a user, the locations based services registration system 108 can request and receive validation information that is used to verify whether the user is actually the user. Validation information can include a user's driver license, a user's voter id, a user's personal account number (PAN), or any applicable data that can be used in verifying the identity of a user. In performing a background check of a user, the location-based services registration system 108 can process validation information according to rules and regulations, e.g. privacy laws.

In a specific implementation, the location-based services registration system 108 can authenticate a user on a per session basis. In authenticating a user, the location-based services registration system 108 can verify whether a user is authorized to user services provided by a location-based services provider system during a session. Depending upon implementation-specific or other considerations, in authenticating a user, the location-based services registration system 108 can verify whether the user has provided necessary login credentials in order to begin a session.

In a specific implementation, the location-based services provider system 110 functions to provide services to users based on a location of the users. Depending upon implementation-specific or other considerations, the location-based services provider system 110 can determine a location of a user based on either a location that is input by the user during registration or a determined position of a user device used by the user. Further depending upon implementation-specific or other considerations, the location-based services provider system 110 can determine a location of a user as they are accessing the location-based services provider system 110 utilizing applicable mechanisms for determining a location of a user device. For example, a user device used by a user can determine its location using a GPS receiver, and then send the determined location to the location-based services provider system 110.

In a specific implementation, in providing services, the location-based services provider system 110 can match users, at least in part, based on locations of the users. In matching users based, at least in part, on locations, the location-based services provider system 110 can match users that are in compatible locations. Depending upon implementation-specific or other considerations, locations are compatible if they are either the same location or neighboring locations. Further depending upon implementation-specific or other considerations, locations are compatible if it is specified in user data that locations are compatible. For example, a user can specify that they are willing to be matched with users within a neighboring zip code.

In a specific implementation, the location-based services provider system 110 functions to provide location-based networking serves. Location-based services include applicable services for matching at least two users based, at least in part, on locations of the users and allowing the at least two matched users to connect. As used in this paper, connecting two matched users includes facilitating communication or exchanging communications between the two users. In exchanging communication, users can be connected through contact modes, examples of which include calling, texting, and video chat. Examples of location-based services include connecting people who are matched based on location for the purposes of matrimony, friendship, donating, or borrowing. For example, the location-based services provider system 110 can match two users having compatible blood types and being within the same location for the purposes of donating blood from one user to the other and subsequently connect the two matched users. Depending upon implementation-specific or other considerations, in providing location-based services, the location-based services provider system 110 can include a platform through which two users can communicate with each other. Further depending upon implementation-specific or other considerations, in providing location-based services, the location-based services provider system 110 can facilitate communication between two users. For example, the location-based services provider system 110 can provide users with e-mail addresses through which the users can communicate.

In a specific implementation, in providing networking services based on location to users, the location-based services provider system 110 can provide networking services according to user data. In providing network services according to user data, the location-based services provider system 110 can match users based on both locations of users and user data of users. For example, if user data for a first user specifies that the first user is willing to donate blood and has blood type O, and user data for a second user specific that the second user is looking to receive a blood donation and has blood type AB, then the location-based services provider system 110 can match and subsequently connect the first user and the second user if they are in compatible locations.

In a specific implementation, the location-based services provider system 110 functions to provide brokering services based on locations of users. Brokering services, as used herein, can include any applicable service of which the completion requires the forfeiture of consideration to a party. Examples of brokering systems include transportation, e.g. a taxi or reserving a spot on public transportation, logistics, and buying and selling of a tangible good or a service.

In a specific implementation, in providing brokering services, the location-based services provider system 110 functions to match users based on location in providing brokering services. In matching users based on location, the location-based services provider system 110 can match users that have compatible locations. Specifically, if a first user is in a compatible location as a second user, then the location-based services provider system 110 can provide brokering services between the first user and the second user. For example, if a first user is in a compatible location as a second user, then the location-based services provider system 110 can offer items to the second user that the first user is trying to sell.

In a specific implementation, the location-based services provider system 110 functions to provide broker services based on user data and location. User data can specify a brokering service a user wants to use. Accordingly, the location-based services provider system 110 can match a first user to a second user who is capable or willing to perform a brokering service that the user data specifies that the first user wants to have performed if the first user and the second user have compatible locations. For example, if user data for a first user specifies the first user wants a package delivered from a first location to a second location, and user data for a second user specifies the second user is willing to pick up and deliver a package to the second location, and it is determined that the second user is at or near the first location, then the location-based services provider system 110 can match and subsequently connect the first user to the second user.

In a specific implementation, the location-based services provider system 110 can generate workflows for transactions associated with brokering services provided by the location-based services provider system 110. As used herein, a transaction is an ongoing action or actions associated with completing a transaction associated with brokering services. For example, a transaction for a brokering service of delivering a package includes picking up the package and delivering the package. Depending upon implementation-specific or other considerations, the location-based services provider system 110 can determine a workflow for a transaction based, at least in part, on a workflow template. For example, the location-based services provider system 110 can generate a workflow for a transaction of delivering an item from a workflow template specifying the item needs to be picked up and subsequently delivered to a specific location. Further depending upon implementation-specific or other considerations, the location-based services provider system 110 can determine a workflow for a transaction based, at least in part, on input received from users participating in the transaction. For example, if a transaction is delivering a package, the location-based services provider system 110 can generate a workflow for the transaction based on user input specifying where the package should be picked up and where the package should be delivered.

In a specific implementation, the location-based services provider system 110 can manage a transaction associated with brokering services provided by the location-based services provider system 110. In managing a transaction associated with brokering services, the location-based services provider system can find users to complete a transaction. Depending upon implementation-specific or other considerations, in managing a transaction associated with brokering services, the location-based services provider system 110 can broadcast to users in a compatible location with a first user that a first user wants a transaction to be performed. For example if a first user wants a package delivered, then the location-based services provider system 110 can broadcast to users in a compatible location as the first user that the first user wants a package delivered. Further depending upon implementation-specific or other considerations, the location-based services provider system 110 can receive an acceptance from a user that a second user is willing to perform actions for carrying out a transaction and send a notification to a first user for whom the transaction will be performed that the second user has agreed to perform the actions. In sending a notification to a user that another user has agreed to perform a transaction, the location-based services provider system 110 functions to “whistle” or otherwise send a service-identifying alert to the user.

In a specific implementation, in managing a transaction associated with brokering services, the location-based services provider system 110 can manage a workflow for the transaction. In managing a workflow for a transaction, the location-based services provider system 110 can send to users associated with a transaction a schedule including a list of actions that need to be completed, and when they need to be completed. For example, if a transaction is delivery of a package, then the location-based services provider system 110 can send a schedule to a user who has agreed to deliver the package including a time and place to pick up the package and a time and place to deliver the package. In managing a workflow for a transaction, the location-based services provider system 110 can receive completion input from a user indicating when actions included in the workflow for the transaction are completed. Depending upon implementation-specific or other considerations, the location-based services provider system 110 can update a viewable workflow to indicate that an action has been completed or send a notification to a user that a transaction has been completed. In sending a notification to a user that an action has been completed, the location-based services provider system 110 functions to “whistle” or otherwise alert the user. For example, if a first user has initiated the transaction of having a package delivered for them, and a second user has picked up the package, then the location-based services provider system 110 can send a notification indicating that the package has been picked up to the first user. Depending upon implementation-specific or other considerations, the location-based services provider system 110 can function to provide notifications to a user who has agreed to perform actions in a workflow for a transaction either or both before the actions are due to be completed, or after the actions are due to be completed.

In a specific implementation, the location-based services provider system 110 provides functionalities to users participating in a transaction associated with brokering services for cancelling the transaction. Depending upon implementation-specific or other considerations, the location-based services provider system 110 can provide functionalities for canceling a transaction either, or both, before a user begins performing actions in a workflow for a transaction or while the user performs the actions in the workflow. In providing functionalities for cancelling a transaction, the location-based services provider system 110 can send notifications to users participating in a transaction that the transaction has been canceled. In sending a notification to a user that a transaction has been canceled, the location-based services provider system 110 functions to “whistle” or otherwise alert the user.

In a specific implementation, the location-based services provider system 110 functions to manage a workflow for multiple transactions associated with brokering services. Depending upon implementation-specific or other considerations, the location-based services provider system 110 can manage a workflow for multiple transactions that are carried out simultaneously. A workflow for multiple transactions that are carried out simultaneously can be referred to as a “journey.” For example, the location-based services provider system 110 can manage a workflow for a user delivering packages for two separate users or two deliveries for the same user. A journey can be specific to a user, a device, or an entity.

In a specific implementation, the location-based services provider system 110 can send match notifications to users once the users are matched with each other. In sending match notifications, the location-based services provider system 110 functions to “whistle” or otherwise alert users that they have been matched. Depending upon implementation-specific or other considerations, match notifications can be sent to a user when they are matched to another user in providing either or both networking services and brokering services. Depending upon implementation-specific or other considerations, the location-based services provider system 110 can send match notifications to users that they are matched either or both during a session or after a session. For example, if a user is logged on during a session to the location-based services provider system 110, and a match is not found during the session but the user is matched after the session, the location-based services provider system 110 can notify the user while the user is not logged on during a session that they have been matched.

In a specific implementation, in providing networking services and brokering services, the location-based services provider system 110 can present a map to a user. A map shown to a user can show locations of other users who utilize services provided by the location-based services provider system 110. Depending upon implementation-specific or other considerations, the location-based services provider system 110 can present a map to a user that shows the location of other users matched to the user in utilizing networking service and brokering services. For example, if a first user and a second user have agreed that the second user will deliver a package for the first user, then the location-based services provider system 110 can present a map to the first user that shows a location of the second user. Further depending upon implementation-specific or other considerations, a location of users on a map presented to a user can be continuously updated as the locations of the users change as the users move. A map shown to a user can also include the locations associated with transactions that are available to perform. For example a map presented to a user can display the locations of packages that need to be delivered.

In a specific implementation, the location-based services provider system 110 can function to facilitate payment between users exploiting services provided by the location-based services provider system 110. Depending upon implementation-specific or other considerations, the location-based services provider system 110 can provide payment portals or provide access to payment portals through which users can furnish payment, including agreed upon consideration for services and/or goods. Further depending upon implementation-specific or other considerations, the location-based services provider system 110 can provide a virtual payment system or provide access to a virtual payment system. A virtual payment system can include an account to which funds can be added. Depending upon implementation-specific or other considerations, a virtual payment system can be funded through any applicable funding means, such as through a telephone.

In a specific implementation, the location-based services provider system 110 can receive payment from users exploiting services provided by the location-based services provider system 110. Depending upon implementation-specific or other considerations, the location-based services provider system 110 can receive payment from users in a subscription-like structure. For example, the location-based services provider system 110 can receive payment monthly from a user for the right to exploit services provided by the location-based services provider system 110. Further depending upon implementation-specific or other considerations, the location-based services provider system 110 can receive payment from users according to a commission-like structure. For example, the location-based services provider system 110 can receive a flat payment for every match it makes, or every time a transaction is completed. In another example, the location-based services provider system 110 can receive a payment that is a percentage of consideration exchanged between users in performing a transaction.

In a specific implementation, the location-based services provider system 110 can provide management services to a user based on a location of a user. Management services can include services that are provided to a user in conjunction with networking services and brokering services provided by the location-based services provider system 110. For example, the location-based services provider system 110 can manage or provide a calendar that includes actions a user needs to complete in conjunction with brokering services or locations that a user must be at in order to meet other users in conjunction with networking services. In another example, in providing management services, the location-based services provider system 110 can manage conflicts associated with networking services and brokering services. Specifically, the location-based services provider system 110 can present available transactions to a user if the user does not have any obligations that conflict with the available transactions.

In a specific implementation, in providing management services, the location-based services provider system 110 can provide functionalities in automated task management based on user location. Depending upon implementation-specific or other considerations, the location-based services provider system 110 can provide functionalities in automated appliance management. Specifically, the location-based services provider system 110 can provide a platform through which a user can configure automated activation or deactivation of an appliance based on the location of the user. For example, a user can configure lights in their home to be turned on when the user is within a one mile radius of the home using the location-based services provider system 110.

In a specific implementation, the location-based services provider system 110 can receive feedback regarding users associated with networking and brokering services provided by the location-based services provider system 110. For example, the location-based services provider system 110 can receive feedback from a first user regarding a second user who performed a transaction for the first user. Depending upon implementation-specific or other considerations, the location-based services provider system 110 can generate or update a score for a user based on received feedback regarding the user. For example, if feedback indicates that a user did not perform a transaction satisfactorily, then the location-based services provider system 110 can generate or update a score for the user to reflect the user's unsatisfactory performance.

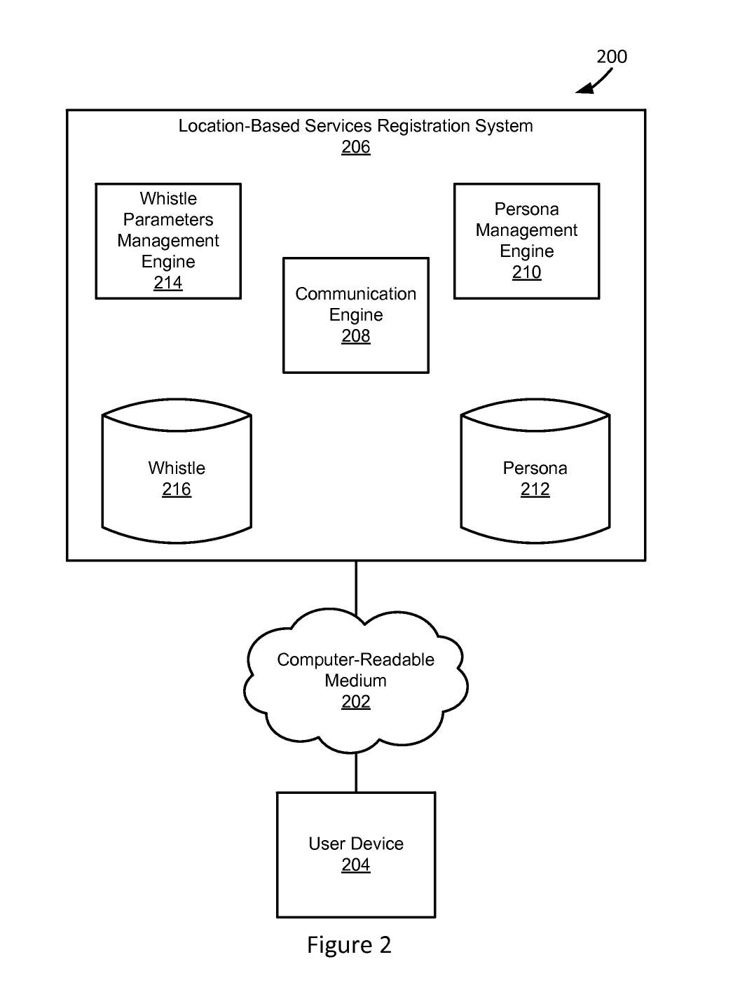

FIG. 2 depicts a diagram 200 of an example of a system for registering users for providing networking services based on location. The example system shown in FIG. 2 includes a computer-readable medium 202, a user device 204, and a location-based services registration system 206. In the example system shown in FIG. 2, the user device 204 and the location-based services registration system 206 are coupled to each other through the computer-readable medium 202.

The user device 202 functions according to an applicable device of a user in providing or gaining access to location-based networking services, such as the user devices described in this paper. The user device 204 includes a display through which a user can interact with the systems in the example shown in FIG. 2. The user device 204 can be configured to determine its own position and transmit its coordinates using an applicable system or method for determining a position of a device, e.g. through GPS, cellular positioning systems, and/or other applicable network positioning systems. Depending upon implementation-specific or other considerations, the user device 204 can be a mobile device that transmits its position for use in providing or obtaining services.

The location-based services registration system 206 functions according to an applicable system for registering a user for providing location-based networking services, such as the location-based services registration systems described in this paper. In a specific implementation, the location-based services registration system functions to gather data describing persona parameters of users, devices, and/or entities. As used in this paper, persona parameters include applicable parameters defining a persona of users, devices, and/or entities. A persona includes characteristics of users, devices, and/or entities utilized in providing location-based networking services. In various implementations, persona parameters can include market segmentation variables including demographic, geographic, psychographic, and behavioristic variables. For example, persona parameters can include an ethnicity and an age of a user. In another example, persona parameters can include activities a user likes performing or has performed. In various implementations, persona parameters can include a rating of a user in providing and/or obtaining services. For example, persona parameters can include a rating from peers of a user in providing services to the peers through location-based networking services. In various implementations, persona parameters include private networks associated with users.

In a specific implementation, persona parameters include characteristics related to the obtaining or providing of services through location-based networking services. In various implementations, persona parameters can include characteristics related to services a user is willing to perform. For example, persona parameters can include services a user is willing to perform and a consideration the user is willing to accept the services. In various implementations, persona parameters can include characteristics related to services a user is interested in having performed through location-based networking services. For example, persona parameters can include services a user wants to be performed and a consideration the user is offering for performance the services.

In a specific implementation, persona parameters include characteristics related to a journey of a device, a user, or an entity. As used herein, a journey includes characteristics related to past or currently ongoing services performed or obtained through location-based networking services. For example, a journey can include services a user has performed in the past or is currently performing. In another example, a journey can include services a user was interested in obtaining, including those services that were performed and those services that were not performed. In various implementations, characteristics related to past or currently ongoing location-based networking services can include an identification of the services and a consideration a user agreed to for performing or obtaining the services through location-based networking services.

In a specific implementation, the location-based services registration system 206 functions to gather data describing whistle parameters. As used in this paper, whistle parameters are parameters controlling the sending of a whistle or an alert to a user, device, or an entity in providing location-based networking services. In various implementations, whistle parameters can dictate whether to send a whistle to a user, device, or an entity matched in providing location-based networking services according to persona parameters. Examples of whistle parameters include a distance between matched users, devices, or entities, a network to send whistles or alerts within, a minimum rating of a user, device, or entity, and times at which to send whistles or alerts. For example, whistle parameters can specify to send whistles to matched users at a specific time every day. In another example, whistle parameters can specify to only send whistles to users with user ratings above a minimum user rating threshold.

In a specific implementation, a whistle parameter includes whether a user, device, or entity has specified private whistling. As used in this paper, private whistling is a parameter specifying that whistles are only to be sent to matched users, devices or entities within a private network. For example, private whistling can specify that whistles are only to be sent to users who are matched to a specific user and within a private network with the specific user. In this example, matched can include users who are matched in terms of persona parameters and/or meet the requirements of whistle parameters. For example, private whistling can specify that whistles are only to be sent to users within a private network of a specific user and within one mile of the specific user.

In a specific implementation, whistle parameters indicate to refrain from displaying an identification of a user to another user matched to the user. For example, if a user has been matched to another user based on common persona parameters, then a whistle parameter of the user can specify to not indicate an identification of the user when sending a whistle to the other user.

In a specific implementation, whistle parameters indicate to provide services to a user at a current location of the user through location-based networking services. For example, a whistle parameter can specify to deliver a package to a user at a current location of a user. Depending upon implementation-specific or other considerations, a current location of a user can be a location of a user at a time at which the user agreed upon a service or a real-time current location of the user. For example, if a user agrees to receive delivery of a package while occupying a first location and subsequently moves to a second location while a package is being delivered, then a whistle parameter can specify to deliver the package to the second location that the user is currently occupying.

In a specific implementation, whistle parameters indicate to send whistles according to whether whistling is activated for a user. For example, a whistle parameter can indicate that a user is to receive whistles while whistling is activated and not receive whistles when whistling is deactivated. Depending upon implementation-specific or other considerations, a user, once activating whistling, can receive all or a portion of whistles generated while whistling was deactivated for the user, according to matches made using either, or both, whistle parameters and persona parameters. For example, if while whistling was deactivated for a user according to a whistle parameter, the user is matched to a second user based on shared persona parameters once whistling is activated, a whistle can be sent to the user indicating that they were matched based on the shared persona parameters while whistling was deactivated.

In a specific implementation, whistle parameters indicate to ask a user who is matched to another user whether they want to send a whistle or an alert before sending the whistle or alert. For example, a whistle parameter can specify to send a message to a user every time the user is matched with other users based on personas before sending a whistle or an alert to the other users.

In the example system shown in FIG. 2, the location-based service registration system 206 includes a communication engine 208, a persona management engine 210, a persona datastore 212, a whistle parameters engine 214, and a whistle datastore 216.

The communication engine 208 functions to send and transmit data used in providing location-based networking services. In sending and transmitting data used in providing location-based networking services, the communication engine 208 can send and receive data that can be organized into persona parameters and/or whistle parameters specific to a user, device, or entity. For example, the communication engine 208 can receive data indicating that a specific user is interested in delivering packages within a region which can be organized into a persona parameter and a whistle parameter indicating the user is willing to deliver packages within the region. Depending upon implementation-specific or other considerations, data collected through the communication engine 208 can be used to define persona parameters and/or whistle parameters. For example, if the communication engine 208 collects data indicating that a user is willing to take dogs to a dog park, and a persona parameter indicating that users are willing to take dogs to a dog park does not exist, then the data can be used to generate a persona parameter indicating that users are willing to take dogs to a dog park.

In a specific implementation, the communication engine 208 is integrated, at least in part, on a device of a user or an entity. Depending upon implementation-specific or other considerations, the communication engine 208 can be a native application residing on a device or a web-based application accessible through a web browser residing on the device.

In a specific implementation, the communication engine 208 sends and receives data used in verifying a device in registering a user or an entity. In verifying a device, the communication engine 208 can send a code to the device that is then provided by a user or an entity for verifying the device. For example, the communication engine 208 can send a code to a user device through a SMS message that the user can input back to the communication engine 208, subsequently verifying the user device.

The persona management engine 210 functions to manage persona data for providing location-based networking services. In managing persona data, the persona management engine 210 can associate persona parameters with users, devices, and/or entities based on received data to define personas for the user, devices, and/or entities. For example, if data received for a user indicates that the user is willing to perform painting services, then the persona management engine can associate a persona parameter indicating that a user is willing to performing painting services with the user. In associating persona parameters based on data received for a user, device, or entity, the persona management engine 210 functions to define a persona specific to a user, device or entity.

In a specific implementation, the persona management engine 210 defines persona parameters for use in describing personas. Depending upon implementation-specific or other considerations, the persona management engine 210 can define a new person parameter if a persona parameter defining a characteristic of a persona does not exist. For example, if a user is interested in obtaining car washing services, and a persona parameter does not exist indicating that a user is interested in obtaining car washing services, then the persona management engine 210 can create the persona parameter for car washing services. Further depending upon implementation-specific or other considerations, the persona management engine 210 can define persona parameters as free forms or as categories and subcategories. For example, the persona management engine 210 can define a first persona parameter describing a dog walker as a subcategory of a persona parameter of pet care services and define a second persona parameter as a dog groomer as another subcategory of the persona parameter of pet care services.

The persona datastore 212 functions to store persona data. The persona datastore 212 can store persona data describing personas specific to users, devices, and/or entities. More specifically, the persona datastore 212 can store persona data describing persona parameters defining personas for users, devices, and/or entities.

The whistle parameters management engine 214 functions to manage whistle data for providing location-based networking services. In managing whistle data, the whistle management engine 214 can associate whistle parameters with users, devices, and/or entities based on data received for the user, devices, and/or entities. For example, if data received for a user indicates that the user only wants to receive whistles between 8 a.m. and 8 p.m., then the persona management engine can associate a whistle parameter indicating that a user only wants to receive alerts between 8 a.m. and 8 p.m. with the user.

In a specific implementation, the whistle parameters management engine 214 defines whistle parameters for use in providing location-based networking services. Depending upon implementation-specific or other considerations, the whistle parameters management engine 214 can define a new whistle parameter if the whistle parameter does not exist. For example, if a user is interested in only being seen to other users within a private network, then the whistle parameters management engine 214 can define a whistle parameter specifying that whistles associated with the user are only to be sent to other users within the private network.

The whistle datastore 216 functions to store whistle data. The whistle datastore 216 can store whistle data describing whistle parameters specific to users, devices, and/or entities. For example, the whistle datastore 216 can store whistle parameters of and/or associated with a user indicating the preferences of the user in receiving.

In an example of operation of the example system shown in FIG. 2, the communication engine 208 sends data to and receives data from the user device 204 related to providing location-based networking services. In the example of operation of the example system shown in FIG. 2, the persona management engine 210 generates persona data for a user by associating persona parameters defining a persona with the user based on the data received from the user device 204. Further, in the example of operation of the example system shown in FIG. 2, the persona management engine 210 stores the generated persona data in the persona datastore 212. In the example of operation of the example system shown in FIG. 2, the whistle parameters management engine 214 generates whistle data for the user by associating whistle parameters with the user based on the data received from the user device 204. Additionally, in the example of operation of the example system shown in FIG. 2, the whistle parameters management engine 214 stores the generated whistle data in the whistle datastore 216.

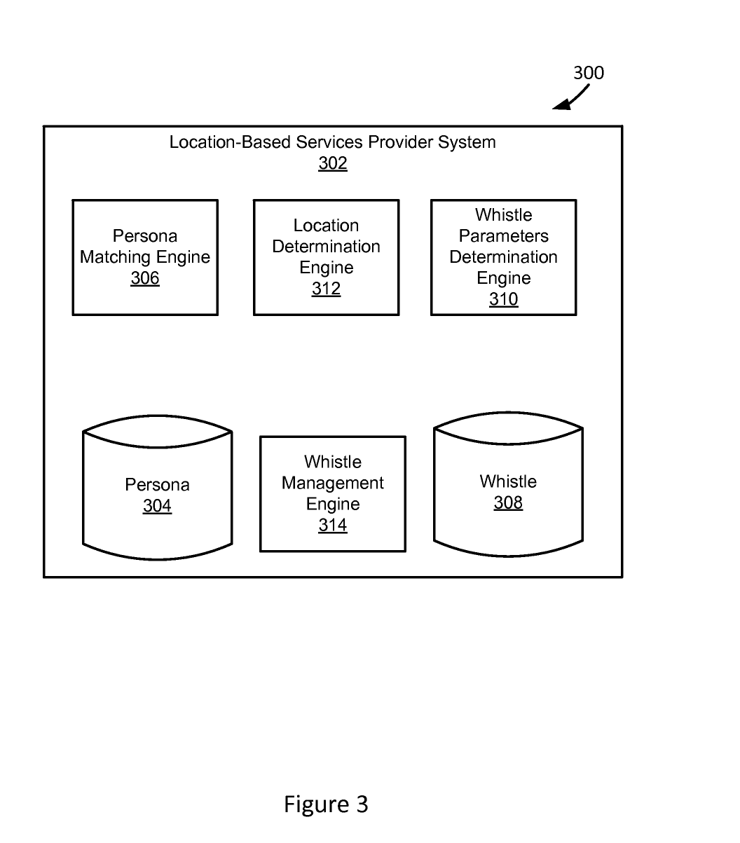

FIG. 3 depicts a diagram 300 of an example of a system for providing location-based services. The example system shown in FIG. 3 includes a location-based services provider system 302. The location-based services provider system 302 functions to provide location-based services to users, devices, and/or entities. In providing location-based services to users, devices, and/or entities, the location services provider system 302 can manage the sending of whistles or alerts to users. Additionally, in providing location-based networking services, the location-based services provider system 302 can match users, devices, and/or entities based on personas and determine whether and how to send a whistle or alert to matched users according to whistle parameters associated with the matched users.

In the example system shown in FIG. 3, the location-based services provider system 302 includes a persona datastore 304, a persona matching engine 306, a whistle datastore 308, a whistle parameters determination engine 310, a location determination engine 312, and a whistle management engine 314.

The persona datastore 304 functions according to an applicable datastore for storing persona data used in providing location-based services, such as the persona datastore described in this paper. The persona datastore 304 can store persona data indicating persona parameters defining personas specific to users, devices, and/or entities.

The persona matching engine 306 functions to match users, devices, and/or entities based on personas for providing location-based services. The persona matching engine 306 can match personas based on persona parameters, included as part of persona data. In matching based on persona parameters, the persona matching engine 306 can determine a match based on shared or related personas parameters. For example, the persona matching engine 306 can match a first user with a second user if persona parameters associated with the first user indicate the first user wants to obtain pet sitting services and persona parameters associated with the second user indicate the second user is seeking to provide pet sitting services. Depending upon implementation-specific or other considerations, the persona matching engine 306 can match users, devices, and/or entities that have a shared or associated number of persona parameters above a threshold. For example, the persona matching engine 306 can match users if it determines that the users have at least one shared or associated persona parameter.

In a specific implementation, the persona matching engine 306 functions to match users, devices, and/or entities according to a radius. As used in this paper, a radius is one or a plurality of constraints in searching for personas and matching personas in providing location-based services. In using a radius to match users, devices, and/or entities, the persona matching engine 306 can use the radius to filter out personas, and then match personas falling within the radius. In various implementations, a radius is defined according to one or a combination of locations, whistle parameters, and/or persona parameters of users, devices, and entities. For example, if a whistle parameter of a user specifies to only return matched users within 10 miles of a location of the user, then the radius can be defined to include all users within 10 miles of the location of the user. In another example, if a whistle parameter specifies to return matched users within a private network of a user, then the radius can be defined to include all users within the private network of the user.

In a specific implementation, the persona matching engine 306 functions to match users, devices, and/or entities according to a journey. In matching based on a journey, the persona matching engine 306 can use a journey to define a radius for filtering out personas. For example, if a user is interested in house painting services, and a journey of the user indicates that they were matched with a provider of house painting services and subsequently received house painting services, then the persona matching engine 306 can define a radius to filter out users who provide house painting services.

The whistle datastore 308 functions according to an applicable datastore for storing whistle data, such as the whistle datastores described in this paper. The whistle datastore 308 can store whistle data indicating whistle parameters specific to users, devices, and entities.

The whistle parameters determination engine 310 functions to determine whistle parameters used in providing location-based services. The whistle parameters determination engine 310 can determine whistle parameters for users, devices, and entities matched through personas. In determining whistle parameters, the whistle parameters determination engine 310 can search through whistle data using identifications of matched users, devices, and entities to determine whistle parameters associated with the matched users, devices, and entities.

The location determination engine 312 functions to determine a location of a device of a user or an entity. The location determination engine 312 can determine a location of a device in real-time according to an applicable method for determining device location. In various implementations, the location determination engine 312 can determine a location of a device based on coordinates received from the device. For example, the location determination engine 312 can determine a location of a device based on coordinates generated through GPS or wireless triangulation.

The whistle management engine 314 functions to manage the sending of whistles in providing location-based services. The whistle management engine 314 can send whistles to users matched based on personas. For example, if a first user and a second user are matched based on a desire to obtain house painting services and a willingness to perform host painting services, as reflected by their corresponding personas, then the whistle management engine 314 can send a whistle to the first user and the second user informing them that they have been matched.

In a specific implementation, the whistle management engine 314 can manage the sending of whistles according to whistle parameters. In managing the sending of whistles according to whistle parameters, the whistle management engine 314 can send whistles to matched users according to whistle parameters associated with the users. For example, if a whistle parameter of a first user matched with a second user indicates that the first user does not want their identity included in the whistle, then the whistle management engine 314 can send a whistle excluding the identity of the first user to the second user. In another example, if a whistle parameter of a first user matched with a second user indicates to send a whistle to the second user if the first user expresses a willingness to connect, then the whistle management engine 314 can send a notification to the first user indicating the match and subsequently send a whistle to the second user if approval is received from the first user.

In a specific implementation, the whistle management engine 314 functions to provide access to a real-time location indicator. A real-time location indicator can be implemented through a map with an indication of a location of a user or a device in real-time as the user or the device remains stationary or is moving. Depending upon implementation-specific or other considerations, a real-time location indicator can be included as part of a whistle, or accessible through an application supporting a whistle. In gaining access to a real-time location indicator, a user can track a location of another user in providing or obtaining services through location-based services. For example, if a first user has been matched with a second user to deliver a package to the location of the second user, then the first user can utilize the real-time location indicator to determine a location at which to deliver the package, even if the second user is moving.

In a specific implementation, the whistle management engine 314 functions to manage workflows of a transaction initiated through location-based services. In managing workflows of a transaction, the whistle management engine 314 can send whistles to parties of a transaction in accomplishing goals within a transaction. For example, if a party is supposed to deliver a package, then the whistle management engine 314 can send reminders to the party to deliver the package, until the package is finally delivered.

In a specific implementation, the whistle management engine 314 functions to determine if users are within a private network in providing location-based services. The whistle management engine can use persona data describing personas specific to a user to determine if a user is in a private network. In determining if users are within a private network, the whistle management engine 314 can manage sending of whistles based on whether users are within a private network. For example, if whistle parameters of a user specify to only send whistles within a private network of the user, and the user is matched with another user who is not in the private network of the user, then the whistle management engine 314 can refrain from sending a whistle to the other user.

In an example of operation of the example system shown in FIG. 3, the persona matching engine matches users in providing location-based services based on personas included as part of persona data stored in the persona datastore 304. In the example of operation of the example system shown in FIG. 3, the whistle parameters determination engine 310 determines whistle parameters associated with the matched users from whistle data stored in the whistle datastore 308. Further, in the example of operation of the example system shown in FIG. 3, the location determination engine 312 determines locations of matched users based on locations of their devices. In the example of operation of the example system shown in FIG. 3, the whistle management engine 314 manages the sending of whistles to the matched users according to the determined locations of the users and the whistle parameters associated with the users.

In another example of operation of the example system shown in FIG. 3, the whistle parameters determination engine 310 determines whistle parameters associated with users while the location determination engine 312 determines locations of the users. In the example of operation of the example system shown in FIG. 3, the persona matching engine 306 defines a radius according to the determined locations of the users and the determined whistle parameters associated with the users. Further, in the example of operation of the example system shown in FIG. 3, the persona matching engine utilized the defined radius to filter out personas of user before matching users based on personas.

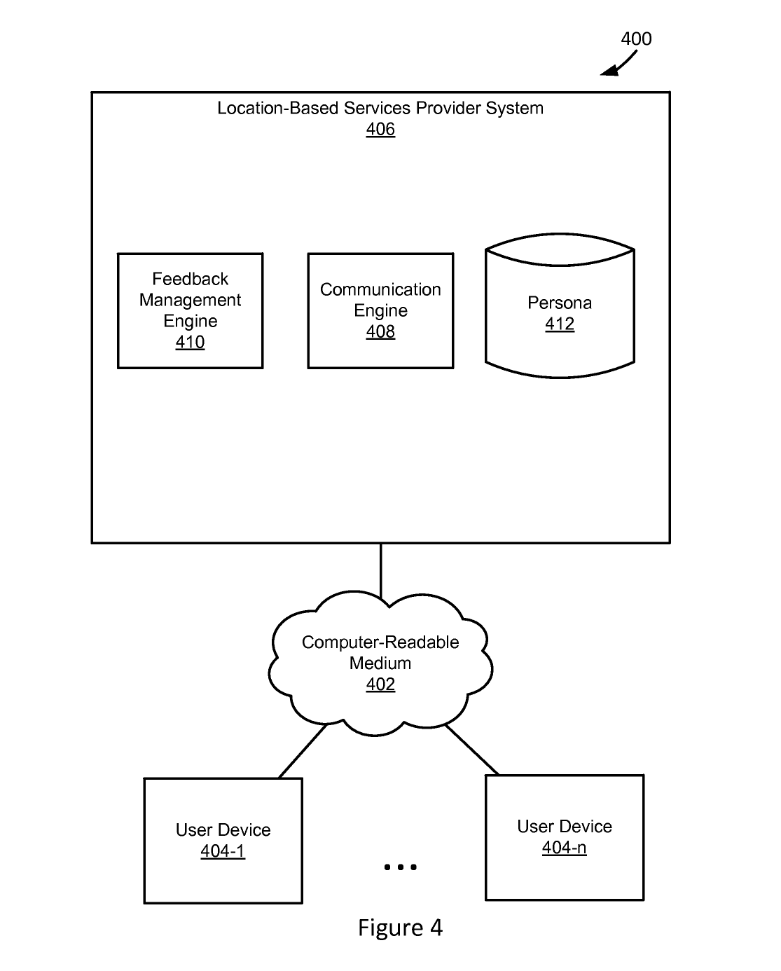

FIG. 4 depicts a diagram 400 of an example of a system for obtaining feedback of users and entities in providing and obtaining location-based services. The example system shown in FIG. 4 includes a computer-readable medium 402, a user device 404-1 . . . 404-n (hereinafter referred to as the “user devices 404”), and a location-based services provider system 406. In the example system shown in FIG. 4, the user devices 404 and the location-based services provider system 406 are coupled to each other through the computer-readable medium 402.

The user devices 404 function according to applicable devices for sending and transmitting data used in providing and obtaining location-based services, such as the user devices described in this paper. The user devices 404 can function to send and receive data for providing feedback of users and entities performing or obtaining services.

The location-based services provider system 406 functions according to an applicable system for providing location-based services, such as the location-based services provider systems described in this paper. The location-based services provider system 406 can function to collect feedback of entities and users for use in providing location-based services.

In the example system shown in FIG. 4, the location-based services provider system 406 includes a communication engine 408, a feedback management engine 410, and a persona datastore 412.

In a specific implementation, the communication engine functions to send data to and receive data from users devices in generating feedback of users and entities in providing and obtaining services for use in providing location-based services. For example, the communication engine 408 can receive a rating of a user in delivering a package to another user. In another example, the communication engine 408 can receive a rating of a user in providing an agreed upon consideration to another user for rendering services. Depending upon implementation-specific or other considerations, a rating can include whether or not a user was liked or whether a user declines to provide a rating. For example, a rating of a first user providing services to a second user is that the second user declines to provide a rating for the first user.

In a specific implementation, the communication engine 408 is integrated, at least in part, on a device of a user or an entity. Depending upon implementation-specific or other considerations, the communication engine 408 can be a native application residing on a device or a web-based application accessible through a web browser residing on the device.

The feedback management engine 410 functions to manage feedback of users and entities in providing services for use in providing location-based services. In managing feedback of users and entities, the feedback management engine 410 can generate and/or update ratings of users or entities as included as part of persona data. For example, if a user receives negative feedback, then the feedback management engine 410 can lower a rating of the user by modifying a persona parameter of the user to reflect the lowered rating. In various implementations, the feedback management engine 410 can generate a rating that is an average of positive feedback compared to negative feedback provided for a user or an entity.

The persona datastore 412 functions according to an applicable datastore for storing persona data, such as the persona datastores described in this paper. Persona data stored in the persona datastore 412 can include personas and associated persona parameters specific to users, devices, and entities. The person datastore 412 can store persona parameters indicating ratings of users and entities.

In an example of operation of the example system shown in FIG. 4, the user devices 404 provide feedback regarding services provided by users or entities through location-based services. In the example of operation of the example system shown in FIG. 4, the communication engine 408 collects the feedback from the user devices 404. Further, in the example of operation of the example system shown in FIG. 4, the feedback management engine 410 generates or updates a rating of the users or entities, as reflected in persona data stored in the persona datastore 412, using the feedback.

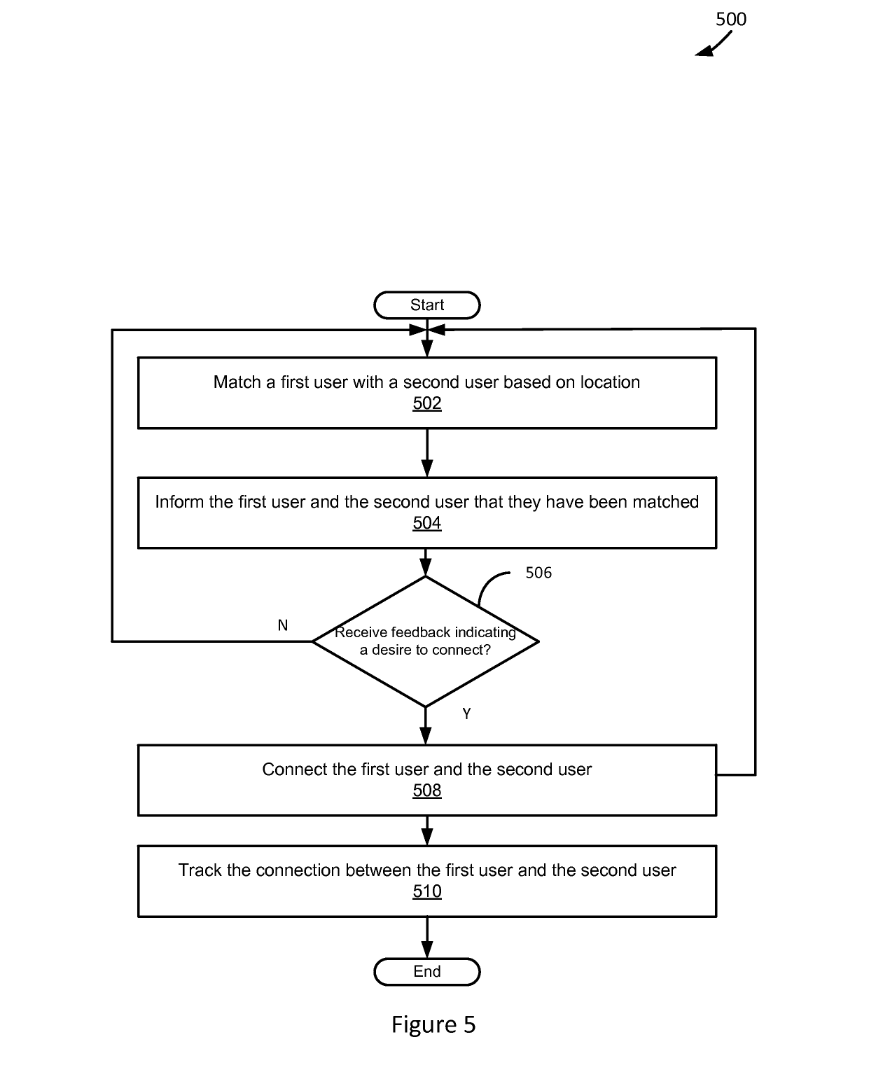

FIG. 5 depicts a flowchart 500 of an example of a method for providing networking services based on user location. The flowchart 500 begins at module 502, where a first user is matched with a second user based, at least in part, on location. Depending upon implementation-specific or other considerations, the first user and the second user can be matched based on either a location of the first user or the second user. Further depending upon implementation-specific or other considerations, the first user and the second user can be matched based on user data of the first user and the second user. For example, user data for the first user can specify that the first user is interested in meeting with people who work at startups and user data for the second user can specify that the second user works at a startup. An applicable engine for matching users based on user data, such as the persona matching engines described in this paper, can function to match the first user and the second user based, at least in part, on location.

The flowchart 500 continues to module 504, where the first user and the second user are informed that they have been matched. In informing the first user and the second user that they have been matched, user data for the users can be sent to the first user and the second user. For example, user data for the second user can be sent to the first user and user data for the first user can be sent to the second user. An applicable engine for informing users that they have been matched, such as the whistle management engines described in this paper, can inform the users that they have been matched. A means for matching can include a processor capable of comparing fields of a data record (either stored as a “record” or some other data structure with an identifiable field associated with the data being compared), a datastore with the relevant data structures to which the processor has access, parameters that indicate what a match entails (normally some form of comparison, which may include a translation logic that converts the meaning of a first field to a first value and the meaning of a second field to a second value, where the first and second values can be qualitatively or quantitatively compared to establish a match or lack thereof), and instructions to cause the processor to perform the steps necessary to make the comparison and establish a match or lack thereof.

The flowchart 500 continues to decision point 506 where it is determined whether feedback is received indicating a desire to connect. Depending upon implementation-specific or other considerations, feedback indicating a desire to connect can be received from either or both the first user and the second user. Further depending upon implementation-specific or other considerations, it can be determined at decision point 506 that feedback is received indicating a desire to connect if feedback indicating a desire to connect is received from both the first user and the second user. An applicable engine for determining whether feedback has been received indicating a desire to connect, such as the whistle management engines described in this paper, can determine whether feedback is received indicating a desire to connect. A means for informing can include a processor capable of providing data from a datastore (such as a buffer into which the relevant data is stored) to the relevant party using output interfaces, relevant drivers, and the like. Informing does not necessarily entail transmission of the data (e.g., the data can be stored and a link to the data can provided in the form of a message that does not actually include the data).

If it is determined at decision point 506 that feedback indicating a desire to connect is absent, then the flowchart 500 continues back to the beginning of the flowchart 500 with matching another user with the first user. If it is determined at decision point 506 that feedback indicating a desire to connect is received, then the flowchart 500 continues to module 508 where the first user and the second user are connected through whistles. Depending upon implementation-specific or other considerations, either contact information of the first user and the second user are provided to the first user and the second user, or a platform is provided through which the first user and the second user can communicate. A means for connecting users entails establishing some form of asynchronous (e.g., email, SMS, or the like) or synchronous (e.g., phone call, socket connection, or the like) between the devices of the users. A connection between devices, as used in this paper, assumes a connection between the users of the devices so connected.

The flowchart 500 continues to module 510 where the connection between the first user and the second user is tracked. In tracking the connection between the first user and the second user, the connection can be managed. In managing the connection, scheduled meetings between the first user and the second user can be managed. An applicable engine for managing a connection, such as the whistle management engines described in this paper, manage the connection between the first user and the second user.

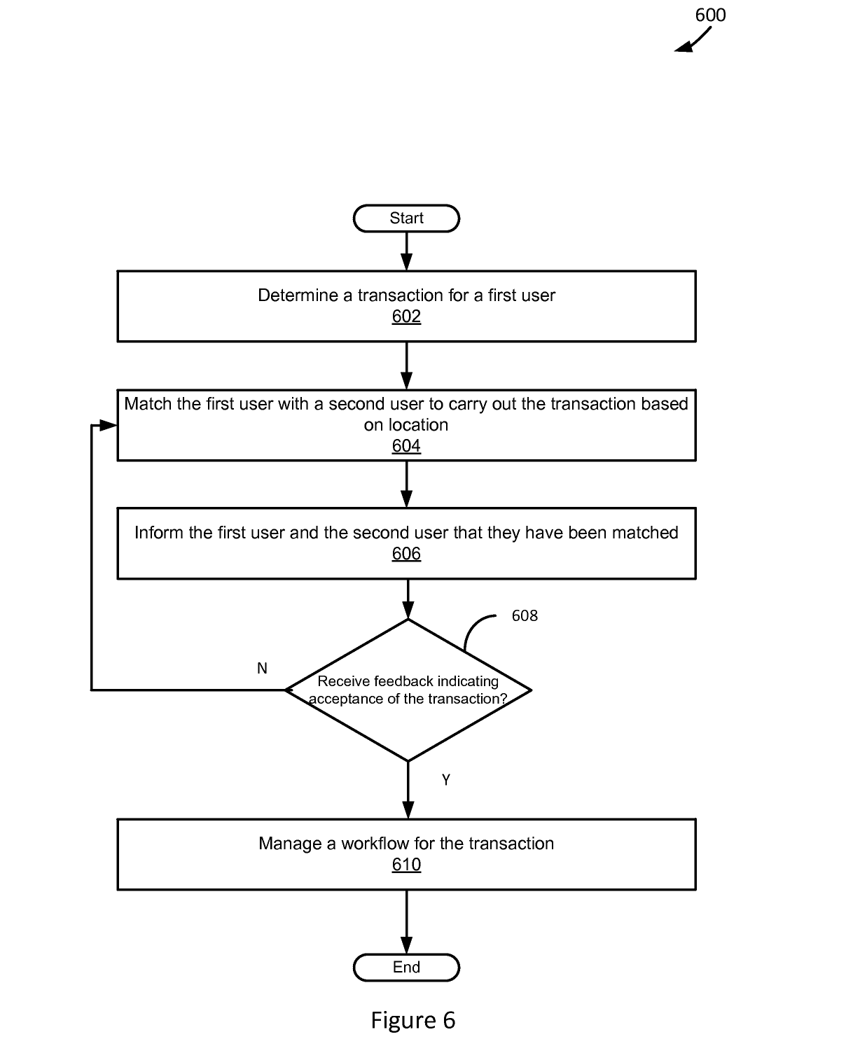

FIG. 6 depicts a flowchart 600 of an example of a method for providing brokering services to users. The flowchart 600 begins at module 602, where a desired transaction for a first user is determined. Depending upon implementation-specific or other considerations, a transaction for a first user can be determined based on user data for the first user. Further depending upon implementation-specific or other considerations, a transaction for a first user can be determined based on input received from the first user. For example, input from a first user can specify that a user wants a package delivered. An applicable engine for recognizing potential transactions, such as the persona matching engines described in this paper, can determine a desired transaction for the first user. A means for tracking a connection indicates the connection between the users also includes a logical internal representation. The logical internal representation includes storage of the state of the connection in an applicable datastore and a processor capable of accessing and updating the logical internal representation to reflect relevant events. Ideally, the logical internal representation will accurately reflect the state of the connection between users, though it is possible the users could establish a connection that is not registered in the applicable datastores (e.g., by shouting to one another instead of using an electronic means of communication).

The flowchart 600 continues to module 604, where the first user is matched with a second user to carry out the transaction based, at least in part, on location. Depending upon implementation-specific or other considerations, the second user can be matched to the first user based on a willingness, as determined from either or both user data for the second user or input received from the second user, to carry out the transaction. Further, in matching the first user with the second user, the second user can be at a compatible location. An applicable engine for matching users based, at least in part, on location, such as the persona matching engines described in this paper, can match the first user with the second user to carry out the transaction.

The flowchart 600 continues to module 606, where the first user and the second user are informed that they have been matched. In informing the first user and the second user that they have been matched, user data for the users can be sent to the first user and the second user. For example, user data for the second user can be sent to the first user and user data for the first user can be sent to the second user. An applicable engine for informing users that they have been matched, such as the whistle management engines described in this paper, can inform the users that they have been matched.

The flowchart 600 continues to decision point 608 where it is determined whether feedback is received indicating acceptance of the transaction. Depending upon implementation-specific or other considerations, feedback indicating acceptance of the transaction can be received from either or both the first user and the second user. Further depending upon implementation-specific or other considerations, it can be determined at decision point 608 that feedback is received indicating acceptance of the transaction if feedback indicating acceptance of the transaction is received from both the first user and the second user. An applicable engine for determining whether feedback is received for approving a transaction, such as the whistle management engines described in this paper, can determine whether feedback is received indicating acceptance of the transaction.

The flowchart 600 continues to module 610, where a workflow for the transaction is managed. In managing a workflow for the transaction, notifications can be sent to the first and second user about actions that need to be completed for the transaction to progress. For example, if the transaction is delivering a package, a notification can be sent to the second user informing them where they need to pick up the package from and when they need to pick up the package. An applicable engine for managing a workflow of transactions, such as the whistle management engines described in this paper, can manage a workflow of the transaction.

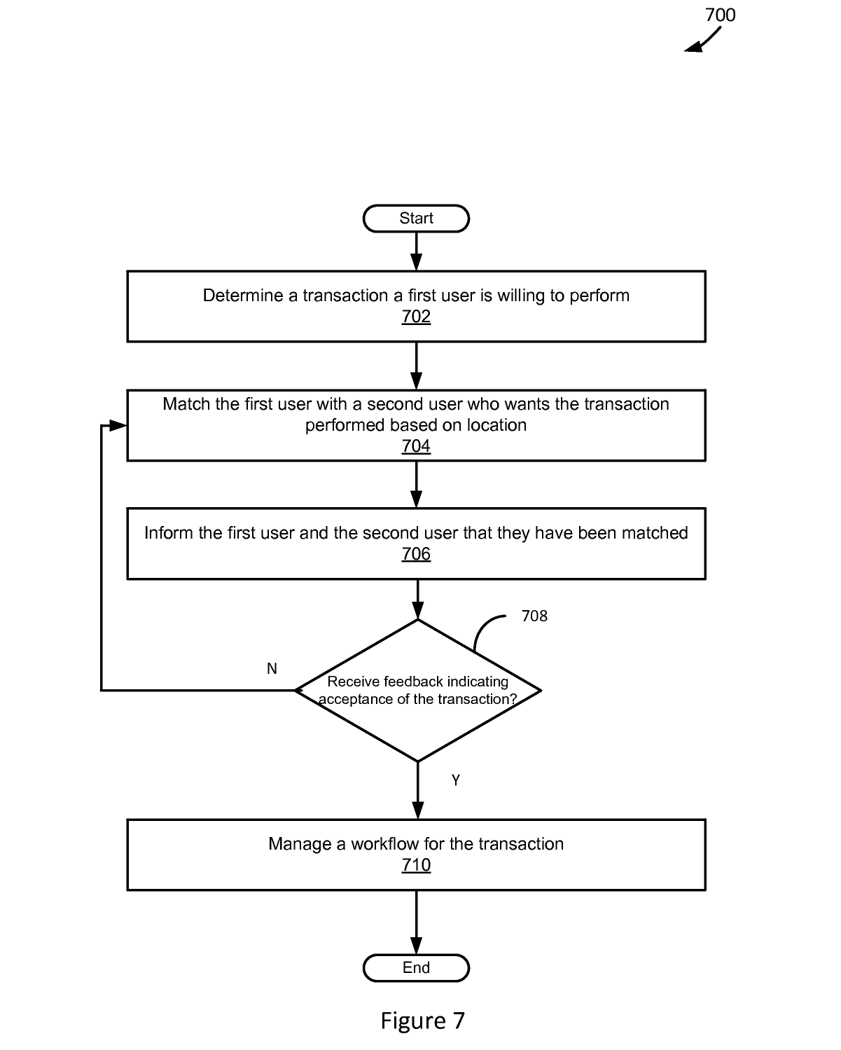

FIG. 7 depicts a flowchart 700 of another example of a method for providing brokering services through location-based services. The flowchart 700 begins at module 702, where a transaction that a first user is willing to perform is determined. A transaction that a first user is willing to perform can be determined from either or both user data for the first user or input received from the first user. For example, the first user can input that they are willing to deliver packages within a certain location, e.g. a city, during a specific time period. An applicable engine for determining transactions, such as the persona matching engines described in this paper, can determine a transaction that a first user is willing to perform.

The flowchart 700 continues to module 704 where the first user is matched with a second user who wants the transaction performed based, at least in part, on location. Depending upon implementation-specific or other considerations, the second user can be matched to the first user based on a willingness to have the transaction carried out for them. Further, in matching the first user with the second user, the second user can be at a compatible location. An applicable engine for matching users, such as the persona matching engines described in this paper, can match the first user with the second user.

The flowchart 700 continues to module 706, where the first user and the second user are informed that they have been matched. In informing the first user and the second user that they have been matched, user data for the users can be sent to the first user and the second user. For example, user data for the second user can be sent to the first user and user data for the first user can be sent to the second user. An applicable engine for informing users that they have been matched, such as the whistle management engines described in this paper, can inform the users that they have been matched.

The flowchart 700 continues to decision point 708 where it is determined whether feedback is received indicating acceptance of the transaction. Depending upon implementation-specific or other considerations, feedback indicating acceptance of the transaction can be received from either or both the first user and the second user. Further depending upon implementation-specific or other considerations, it can be determined at decision point 408 that feedback is received indicating acceptance of the transaction if feedback indicating acceptance of the transaction is received from both the first user and the second user. An applicable engine for determining whether feedback is received indicating acceptance, such as the whistle management engines described in this paper, can inform determine whether feedback is received indicating acceptance of the transaction.

The flowchart 700 continues to module 710, where a workflow for the transaction is managed. In managing a workflow for the transaction, notifications can be sent to the first and second user about actions that need to be completed for the transaction to progress. For example, if the transaction is delivering a package, a notification can be sent to the second user informing them where they need to pick up the package from and when they need to pick up the package. An applicable engine for managing workflow of transactions, such as the whistle management engines described in this paper, can manage a workflow of the transaction.

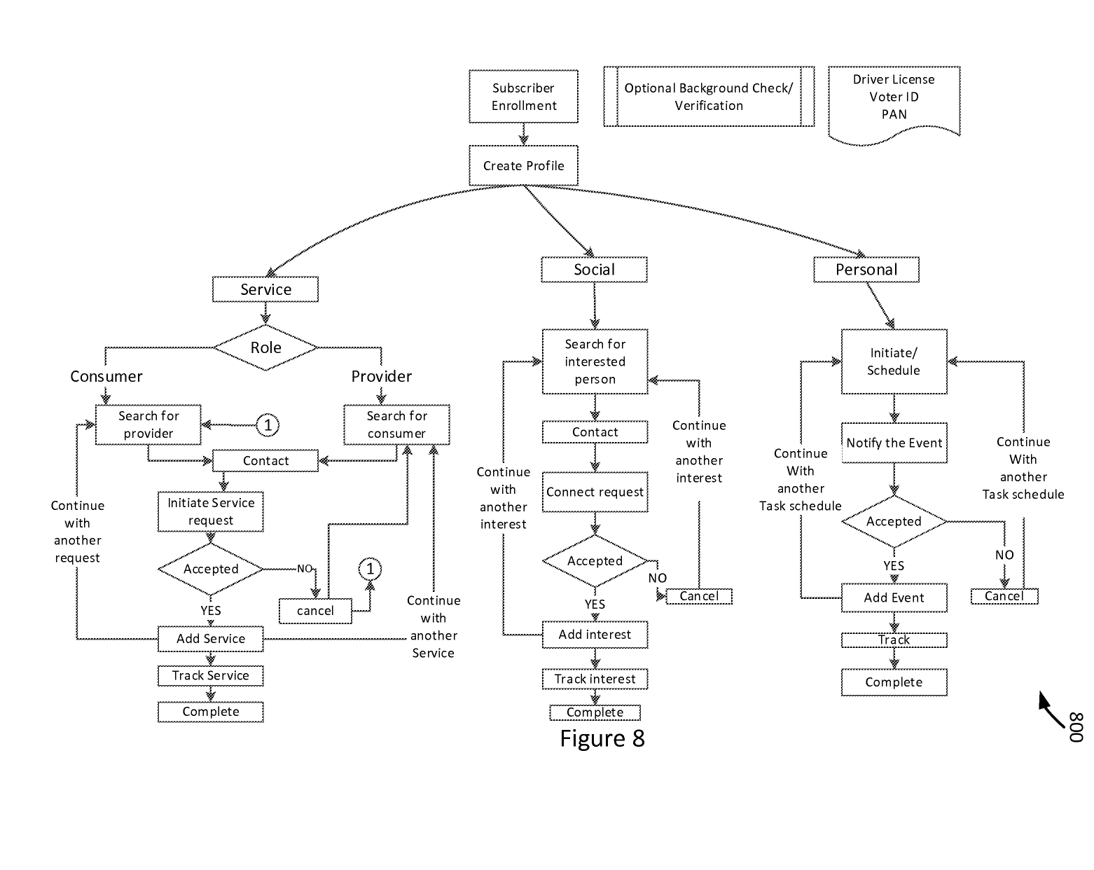

FIG. 8 depicts an example of a flowchart 800 for providing location-based services including brokering services, and management services based on user location.

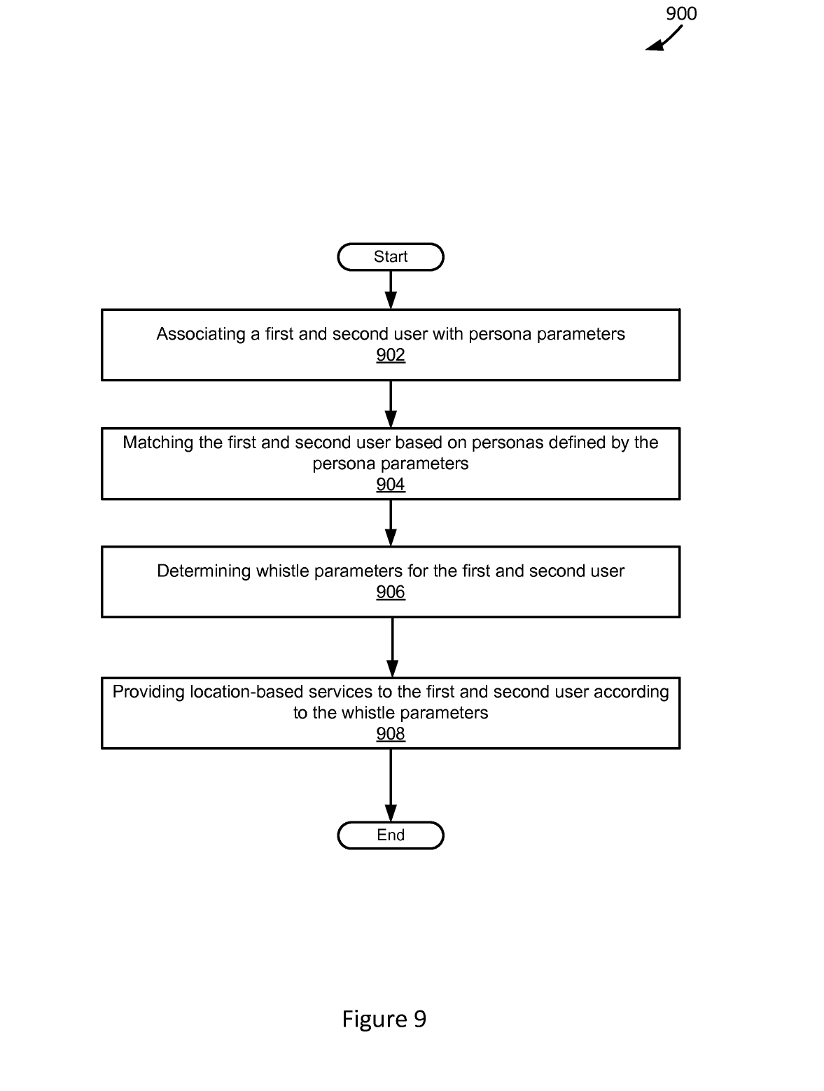

FIG. 9 depicts a flowchart 900 of an example of a method for providing location-based services to users by matching personas. The flowchart 900 begins at module 902, where a first user and a second user are associated with persona parameters. An applicable engine for associating persona parameters with users, such as the persona management engines described in this paper, can associate a first and second user with persona parameters. A first and second user can be associated with persona parameters based on data received from the first and second users. For example, if a first user indicates that they are interested in providing cleaning services, then the first user can be associated with a persona parameter indicating that they are interested in providing cleaning services.

The flowchart 900 continues to module 904, where the first user and the second user are matched based on personas defined by the persona parameters. An applicable engine for matching users based on personas, such as the persona matching engines described in this paper, can match the first and second user based on personas defined by the persona parameters. The first and second user can be matched based on shared or related persona parameters. For example, if a persona parameter indicates that the first user is interested in obtaining house cleaning service and a persona parameter indicates that the second user is offering house cleaning services, then the first user and the second user can be matched.

The flowchart 900 continues to module 906, where whistle parameters are determined for the first user and the second user. An applicable engine for determining whistle parameters, such as the whistle parameters determination engines described in this paper, can determine whistle parameters for the first user and the second user. Whistle parameters can be determined from whistle data generated for the first user and the second user.

The flowchart 900 continues to module 908, where location-based services are provided to the first and second user according to the whistle parameters. An applicable engine for providing location-based services, such as the whistle management engines described in this paper, can provide location-based services to the first and second user. In providing location-based services, whistles can be sent to the first and second user indicating that they have been matched and what services for which they have been matched.

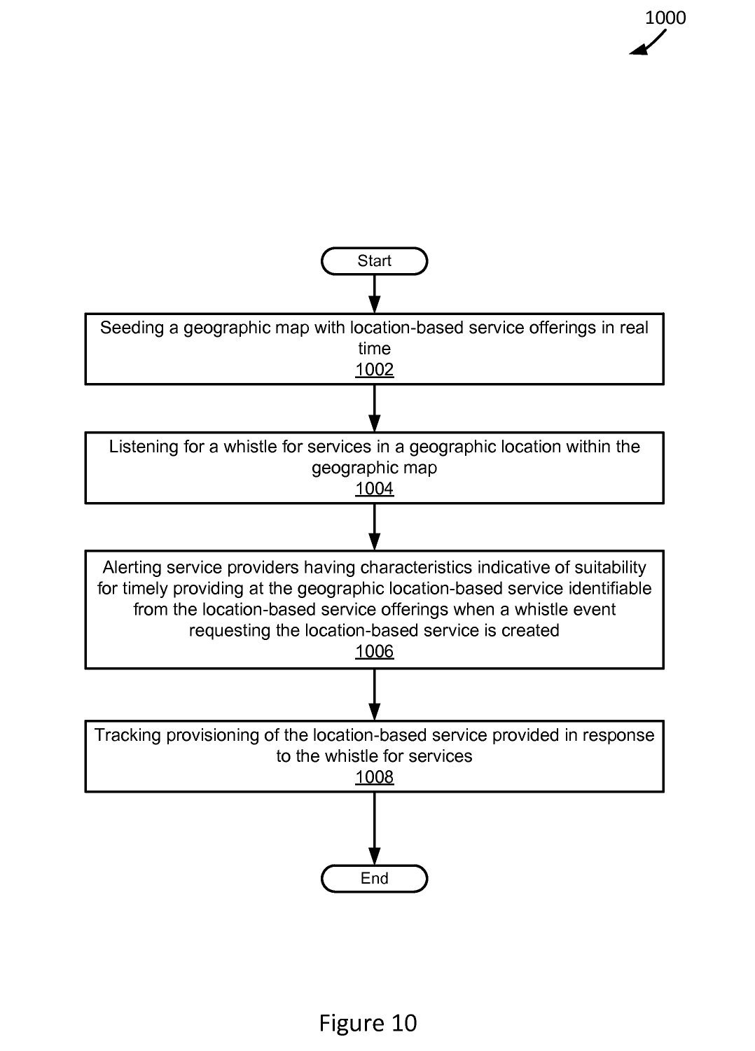

FIG. 10 depicts a flowchart 1000 of an example of a method for provisioning location-based services. The flowchart 1000 begins at module 1002 where a geographic map is seeded with location-based services offerings in real time. A location-based service offering includes services a user is willing to perform and where the user is willing to perform the service. Location-based service offerings can be indicated by persona parameters and/or whistle parameters of a user or an entity. An applicable engine for seeding a geographic map, such as whistle management engines described in this paper, can seed a geographic map with location-based service offerings. A geographic map can be seeded with location-based service offerings according to either or both persona parameters and whistle parameters. For example, if whistle parameters and persona parameters indicate that a user is offering car washing services within 30 miles of their location, then a geographic map can be seeded with the location-based service offering of performing car washing services within 30 miles of the location of the user in real-time, even as the user moves.

The flowchart 1000 continues to module 1004, where a whistle for services in a geographic location within the geographic map is monitored. An applicable engine for monitoring a whistle for services, such as the whistle management engines and persona matching engines described in this paper, can listen for whistles for services in a geographic location within the geographic map. In listening for services, applicable persona parameters to match based on whistles for services can be determined.

The flowchart 1000 continues to module 1006, where service providers having characteristics indicative of suitability for timely providing at the geographic location a location-based service identifiable from the location-based service offerings when a whistle event requesting the location-based service is created, are alerted. An applicable engine for sending alerts, such as the whistle management engines working in conjunction with the persona matching engines, the location determination engines, and the whistle parameters determination engines described in this paper, can alert service providers having characteristics indicative of suitability for timely providing at the geographic location a location-based service identifiable from the location-based service offerings when a whistle event requesting the location-based service is created. A whistle event requesting the location-based service can be associated as part of a whistle parameter and/or a persona parameters with a user or entity. Characteristics can be defined according to persona parameters and/or whistle parameters. Whether a location-based service is suitable for timely providing can be determined based on either or both persona parameters and whistle parameters.

The flowchart 1000 continues to module 1008, where provisioning of the location-based service providing in response to the whistle for services is tracked. An applicable engine for tracking service provisioning, such as the whistle management engines described in this paper, can function to track provisioning of the location-based service providing in response to the whistle for services. A track of the provisioning of the location-based service can be included as part of a journey of a user or an entity.

These and other examples provided in this paper are intended to illustrate but not necessarily to limit the described implementation. As used herein, the term “implementation” means an implementation that serves to illustrate by way of example but not limitation. The techniques described in the preceding text and figures can be mixed and matched as circumstances demand to produce alternative implementations.

We claim:

1. A method comprising:
seeding a geographic map with location-based service offering in real-time;
listening for a whistle for services in a geographic location within the geographic map;
alerting service providers having characteristics indicative of suitability for timely providing at the geographic location a location-based service identifiable from the location-based service offerings when a whistle event requesting the location-based service is created;
tracking provisioning of the location-based service provided in response to the whistle for services.
